(19) United States
(12) Patent Application Publication
(10) Pub. No.: US 2009/0296421 A1
(43) Pub. Date: Dec. 3, 2009

(54) SUPPORT MODULE INCLUDING A FIBRE OPTIC LIGHTING SYSTEM FOR BOTTLES

(76) Inventor: Carlos Fernandez-España, Coruna (ES)

Correspondence Address: MERCHANT & GOULD PC, P.O. BOX 2903, MINNEAPOLIS, MN, 55402-0903, US

(21) Appl. No.: 12/092,907

(22) PCT Filed: May 19, 2006
(86) PCT No.: PCT/ES2006/000267

§ 371 Date: Jan. 5, 2009

(30) Foreign Application Priority Data
Nov. 7, 2005 (ES) U200502499

(51) Int. Cl. G02B 6/02

(52) U.S. Cl. 362/551

(57) ABSTRACT

The invention relates to a support module including a fiber optic lighting system for bottles, characterized by an internal or external light-emitting core from which light is conveyed by means of fiber optic into a bottle that is suspended by a fixing system from a hollow element having a triangular cross-section. The aforementioned fixing system comprises a hollow screw into which the optic fiber is introduced and said fixing system is placed inside a bottle and fixed to the triangular base.

### OBJECT OF THE INVENTION

The present specification relates to a support module with a fiber optic lighting system for bottles, the purpose of which is based on emitting or projecting light continuously, intermittently and/or with a color change inside the bottles in addition to suspending them and fastening them to a support base.

The system is formed by a light emitter located in the inner or outer part of the bottle supporter, connected to the mains power supply, and by a fiber optic cable harness through which the light is conveyed from the light emitter into the bottles in which the distributed fiber optic cables are housed so as to obtain the desired lighting.

### FIELD OF THE INVENTION

This fiber optic lighting system is applicable in the industry dedicated to the manufacture of apparatus and instruments for conducting, distributing, transforming, regulating and controlling light.

### BACKGROUND OF THE INVENTION

The applicant knows of the current existence of the plurality of apparatus and instruments for conducting, distributing, accumulating, regulating and controlling electricity and light.

The applicant also knows of the existence of decorative and functional fiber optic lighting systems operating through a light-emitting core and a fiber optic harness.

The applicant also knows of the existence of fiber optic lighting systems with color variation and intermission.

However, the applicant does not know of the current existence of an invention which allows lighting with a color change and/or intermission adapted to bottles and which is furthermore useful for the fastening of same.

### DESCRIPTION OF THE INVENTION

The support module with a fiber optic lighting system for bottles provided by the invention is configured as an evident novelty which allows the fastening and inner lighting of bottles with a color change and/or intermission of the light.

More specifically, the support module with a fiber optic lighting system for bottles object of the invention is formed by a closed internal or external light-emitting core containing a blower, the lamp, the rotation motor of the color and/or intermission disk and the color and/or intermission disk itself which will be responsible for producing the color change and/or intermission inside bottles. Coming out of this emitting core there is a series of fiber optic cables which convey said light into the fastening system which is introduced in the bottles to be lit up, these bottles are fixed to an element to suspend them. Attached to this specification as an integral part thereof there are three sheets of drawings in which the following is shown in an illustrative and non-limiting manner:

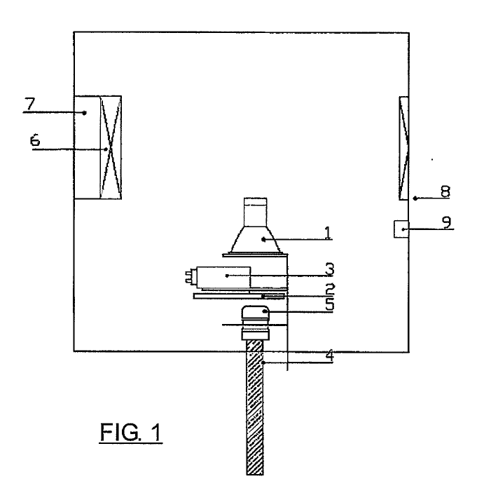

FIG. 1 shows a top view of a light emitter outside the beverage dispensing tap.

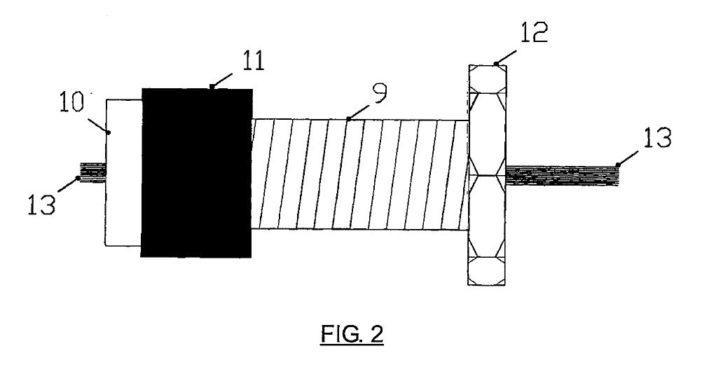

FIG. 2 relates to the support-lighting system object of the invention in which the fiber optic is fixed within the fastening to light up and fasten the bottles to a suspending system for such bottles.

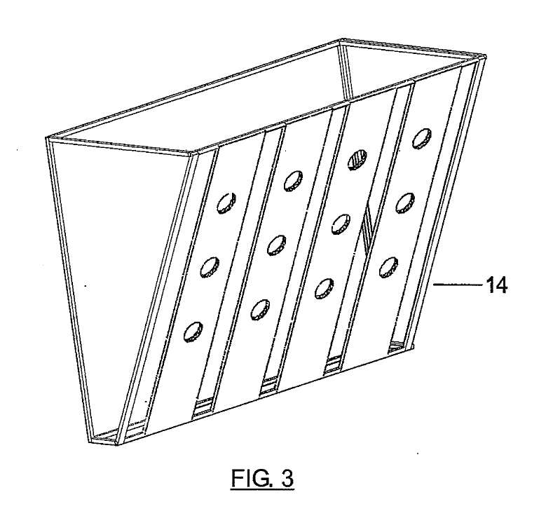

FIG. 3 relates to the bottle suspending system.

### PREFERRED EMBODIMENT OF THE INVENTION

A breakdown of the support module with a fiber optic lighting system for bottles can be observed in FIGS. 1, 2 and 3, which module is formed by an emitting core inside or outside the suspending element, connected to the mains power supply, said emitter being enclosed in a casing with forced ventilation through an air inlet (8) and an air outlet (7), the emitter further being formed by a blower (6), a halogen lamp (1), a color and/or intermission disk (2) rotating by means of a motor (3) and a fiber optic cable harness (4), which cables merge in an optical port (5) which will receive light from the halogen lamp (1). The fiber optic harness (4) distributes the fiber optic cables (13) into the hollow screw of the fixing system (9) for the bottles which will be introduced in the opening of same for its fastening to the module (14).

It is considered unnecessary to further expand this description for a person skilled in the art to understand the scope of the invention and the advantages derived from same.

The materials, shape, size and arrangement of the elements may vary provided that this variation does not involve an alternation of the essential nature of the invention.

The terms used for the description in this specification must always be considered in a broad and non-limiting sense.

1. A support module with a fiber optic lighting system for bottles, comprised by an internal or external light-emitting core from which light is conveyed by means of fiber optic into a bottle that is suspended by a fixing system from a hollow element having a triangular cross-section, the fixing system being formed by a hollow screw into which the fiber optic is introduced and this fixing in turn being placed inside a bottle and fixed to the triangular base.

2. A module according to claim 1, characterized by wherein an external light emitter formed by a blower, inlet and outlet ventilation ducts, a halogen lamp, a color and/or intermission disk rotating by means of a motor and a fiber optic cable harness, which cables merge in an optical port

3. A module according to claim 1, characterized by wherein a hollow screw having at one end a part fixed to the screw (or mobile and threading) and also hollow with a larger diameter than that of the screw, the screw being introduced into a hollow and flexible cylindrical volume, the fiber optic being introduced from one end of the screw to the other and is fixed, at the other end to that of the fixed part of the screw a nut screwed on, which nut, when screwed on, makes the system tighten against the hollow plate of the support where the bottle is fixed and the flexible part expands, tightening against the inner walls of the bottle, causing the fastening of same.

4. A module according to claim 1, wherein a support with a triangular longitudinal section which can be fixed to a wall or to the ceiling and rotate in the manner considered appropriate.
